(19) United States
(12) Patent Application Publication
(10) Pub. No.: US 2016/0224960 A1
(43) Pub. Date: Aug. 4, 2016

(54) ORDER AND PAYMENT SYSTEM

(71) Applicant: IFPL GROUP LIMITED, Newport Isle of Wight (GB)

(72) Inventors: Geoffrey Paul UNDERWOOD, Calbourne, Isle of Wight (GB); Mark Tyler REED, Sandown, Isle of Wight (GB); Neil Jonathon THOMAS, Bembridge, Isle of Wight (GB)

(21) Appl. No.: 14/914,953

(22) PCT Filed: Aug. 29, 2014
(86) PCT No.: PCT/GB2014/052619

§ 371 Date: Feb. 26, 2016

(30) Foreign Application Priority Data
Aug. 29, 2013 (GB) 1315417.4

(51) Int. Cl. G06Q 20/20; G06Q 20/32

(52) U.S. Cl. CPC G06Q 20/204; G06Q 20/322

(57) ABSTRACT

A payment and ordering device (10) for products and/or services for use by a customer, the device comprising a reader to contactlessly read a payment credential, a customer input arrangement (12) for receiving a customer's input as to a desired product or service, the device comprising a transmitter to transit the customer's product/service selection and payment credential data to a server.

### TECHNICAL FIELD

The present invention relates to an order and payment system.

### SUMMARY

According to the first aspect of the invention there is provided a payment and ordering device for products and/or services for use by a customer, the device comprising a reader to contactlessly read a payment credential, a customer input arrangement for receiving a customer's input as to a desired product or service, the device comprising a transmitter to transmit the customer's product/service selection and payment credential data to a server.

The data may be sent to the server over an air interface or by way of a wired connection.

The device may comprise a screen to display information to a customer.

The device may comprise a transceiver.

By “contactlessly” we include the meaning that the payment credential need not necessarily physically come into contact with the module in order for the module to read the payment data.

The device may comprise an e-ink enabled display.

The display may be a touch screen display.

The device may comprise a data processor.

The device may comprise a battery.

The device may be arranged to be in a standby mode until activated by an input by the customer.

The transmitter may be arranged to send information over an air interface.

The reader may be arranged to communicate with a suitably enabled bank or credit card. The bank or credit card may comprise a chip or tag. The reader may be arranged to receive signals from a suitably enabled mobile telephone handset (such as by way of a smart-phone eWallet).

The device may comprise a module which is arranged to be secured to an aircraft seat. The module may be arranged to be attached to the rear of a passenger seat.

The device may be arranged to display a selection of purchase options, and to allow a user to select at least one of those options.

The device may be arranged to display product selection confirmation, and purchase instructions for the customer.

The device may be arranged to display data indicative of the status of an order.

The reader may be enabled to perform near field communication with the payment credential.

According to a second aspect of the invention there is provided an ordering and payment system comprising at least one device of the first aspect of the invention, a data processor to receive order and payment information from the at least one device and the data processor arranged to output order information to be actioned.

The system may comprise a plurality of devices.

The system may comprise an output device to display order information.

Other aspects of the invention relate to any combination of the above features and/or features disclosed in the description/and or drawings.

### BRIEF DESCRIPTION OF THE DRAWINGS

Various embodiments of the invention will now be described, by way of example only, with reference to the following drawings in which:

FIG. 1 is a schematic representation of an order and payment system, and

FIG. 2 is a front elevation of a customer ordering and payment system.

### DETAILED DESCRIPTION

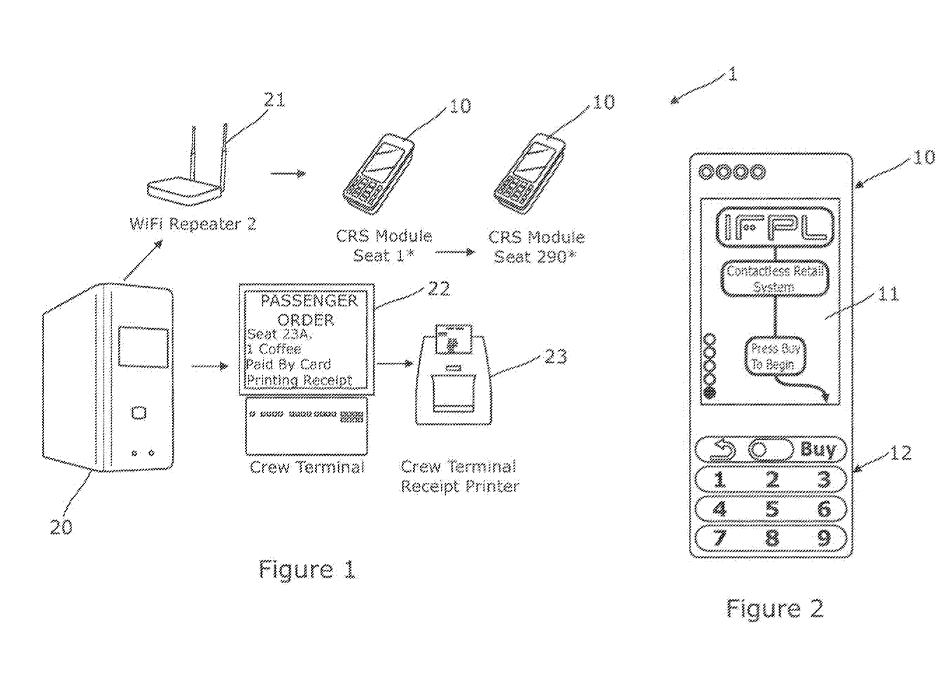

With reference to FIG. 1 there is shown a system 1 which comprises a network of nodes which is a product ordering and payment system. As will be described below, the system conveniently enables customers to order and pay for products offered. The embodiment described below is in the context of implementation in an aircraft, however numerous other applications are equally possible, such as in a restaurant or café.

Broadly, the system comprises a plurality of modules 10 which are provided for each passenger. Each module, or terminal, 10 is installed and mounted to the rear of each seat. The modules may be installed by way of provisioning a cut-out at the rear of each seat. The modules are then installed in the cut-out provided. Each module 10 is then commissioned so that it relates to the seat number at which it is installed. This involves configuring a data processor of the module to store an identifier which is representative of the seat location for the module.

Each module 10 comprises a data processor, a payment credential reader, a transmitter, a display screen and an input keypad. The module 10 is advantageously provided with a self-contained battery and therefore does not require connection to an external power source. The battery is preferably a long-life battery with a life in excess of two years. However, in some embodiments the modules 10 may be arranged to be connected to an external power supply.

The on-board data processor and memory enable the module 10 to perform its required functionality. As outlined above, the individual unit address of each module 10 is settable by way of an externally accessible programming point.

The module 10 comprises a payment credential reader which employs Near Field Communication to communicate with a payment credential such as a suitably enabled credit or bank card which includes a tag or chip for that purpose. The reader enables the payment credential to be brought close to the module 10. The reader senses and communicates with the credential and pulls the credential identifying information from the credential in a contactless manner over an air interface. The module 10 may also be enabled to take payment credential information from an eWallet smart-phone.

The module 10, as seen in FIG. 1, comprises a screen 11 and a keypad 12. The screen 11 is arranged to display information to the customer wishing to order and pay for a product or service. The information includes details of the products/services offered, and information relating to the payment. The information may further include confirmation that an order has been sent and is being processed. The keypad 12 allows the customer to select various options, such as which product/service is required the quantity required. The information is stored in the memory of the module 10 and is caused to be selectively displayed by way of suitable control instructions executed by the data processor. The information displayed by the module 10 may be menu-driven.

The module 10 includes a wireless transmitter arranged to send information over an air interface to an order and payment processor 20, via a repeater station 21, as shown in FIG. 2. It will be appreciated that in other embodiments the information need not necessarily be sent over an air interface, and could be an alternative type of interface.

In use, on the customer selecting and paying for one or more selected items using the respective module 10, data representative of the order details, payment credential data and the customer's seat number is wirelessly transmitted from the module 10 to the processor 20, via the repeater 21.

On receipt of the data, the processor 20 securely processes the payment details. The processor then causes an output to be issued at a terminal 22, the display screen of which displays details of the order including items ordered, the customer seat number and the method of payment. A staff member can then view the details and prepare the order to then be taken to the customer. A printer terminal 23 may be provided to print a receipt for the customer in respect of the transaction.

The system 1 is highly convenient for both the customer and the purveyor. From the customer's prospective, he can easily and quickly place an order, including payment therefore. From the purveyor's point of view, staff can avoid the need to handle cash to take payment for an order. In particular, this obviates the need for staff to carry cash change if, as is often the case, the customer does not carry the exact amount of cash to pay for the products(s) ordered.

The above system 1 may be described as a contactless retail system.

Ease of installation of the system 1 is enhanced by the modules 10 not requiring wiring to physically connect them to the aircraft wiring. Furthermore, use of an e-ink display for the module 10, reduces power consumption and prolongs life of the battery.

The module's 10 default operating condition is standby mode. By way of a manual input from the customer, for example by pressing one of the keypad buttons, the module then transitions into an ON mode to enable the customer to place and pay for an order.

In an alternative embodiment, the module is arranged to receive power from a wired connection to an existing power supply, for example in the case of implementation to an aircraft, the module could be connected to a power supply from an existing inflight entertainment system (IFE).

In another variant, the payment and order data may be transmitted from the module to the server by way of a wired connection (for example when wire connected to an existing IFE).

In yet a further variant, the module may be arranged to transmit data, such as e-vouchers or e-credentials, to a customer's mobile phone device, smartphone, personal computer or tablet, which is within proximity of the module.

1. A payment and ordering device for products and/or services for use by a customer, the device comprising a reader to contactlessly read a payment credential, a customer input arrangement for receiving a customer's input as to a desired product or service, and a transmitter to transit the customer's product/service selection and payment credential data to a server.

2. The device of claim 1, further comprising a screen to display information to a customer.

3. The device of claim 1, further comprising a transceiver.

4. The device of claim 1, further comprising an e-link enabled display.

5. The device of claim 1, further comprising a data processor.

6. The device of claim 1, wherein the device is arranged to be in a standby mode as a default condition.

7. The device of claim 1, wherein the reader is arranged to communicate with a suitably enabled bank or credit card.

8. The device of claim 1, further comprising a module which is arranged to be secured to an aircraft seat.

9. The device of claim 1, wherein the device is arranged to display a selection of purchase options, and to allow a user to select at least one of those options.

10. The device of claim 1, wherein the device is arranged to display product selection confirmation, and purchase instructions for the customer.

11. The device of claim 1, wherein the reader is enabled to perform near field communication with the payment credential.

12. The device of claim 1, further comprising a battery to power the device.

13. The device of claim 1, wherein the transmitter is arranged to send information over an air interface.

14. An ordering and payment system comprising at least one device in accordance with claim 1, a data processor to receive order and payment information from the at least one device over and the data processor arranged to output order information to be actioned.

15. The system of claim 14, further comprising a plurality of devices.

16. The system of claim 14, further comprising an output apparatus to display order information received from the device.
